(19) United States
(12) Patent Application Publication
(10) Pub. No.: US 2026/0346986 A1
(43) Pub. Date: Nov. 5, 2026

(54) SEAT SYSTEM FOR AIRPLANE AND AIRPLANE HAVING THE SAME

(71) Applicants: Young Seo CHO, Paju-si (KR); Young Jai CHO, Paju-si (KR)

(72) Inventors: Young Seo CHO, Paju-si (KR); Young Jai CHO, Paju-si (KR)

(21) Appl. No.: 19/739,861

(22) Filed: Jul. 13, 2026

Related U.S. Application Data
(63) Continuation-in-part of application No. 19/684,315, filed on May 21, 2026.
Application No. 19/684,315 is a division of application No. 18/215,089, filed on Jun. 27, 2023, now abandoned.

(51) Int. Cl. B64D 11/06

(52) U.S. Cl. CPC B64D 11/0601

(57) ABSTRACT

Disclosed are a seat system for an airplane and an airplane having the same. The seat system for the airplane of the present disclosure includes a lower seat system provided in a first space part of an airplane body; and an upper seat system provided in a second space part disposed above the first space part, in which the upper seat system includes a plurality of seat parts, the plurality of seat parts have at least one arrangement structure selected from a V-shaped arrangement structure, a linear arrangement structure, and a serial arrangement structure, and the plurality of seat parts are continuously arranged.

### CROSS-REFERENCE TO RELATED APPLICATIONS

This application is a Continuation-in-Part application of U.S. application Ser. No. 19/684,315, filed May 21, 2026, which is a divisional application of U.S. application Ser. No. 18/215,089, filed Jun. 27, 2023, the disclosures of which are incorporated herein by reference.

### BACKGROUND OF THE INVENTION

### Field of the Invention

The present disclosure relates to a seat system, and more particularly, to a seat system for an airplane and an airplane having the same capable of increasing space efficiency and making it possible for a passenger to visually feel stability and luxury in a cabin space by combining an upper seat system and a lower seat system.

### Description of the Related Art

An airplane is an object that may fly through the air while carrying people or goods by using the lift of fixed wings.

These airplanes may be classified into several types depending on a use, a propulsion method, a wing shape, etc.

Among the airplanes, airliners are intended to transport people and have seats from at least 20 to 800. For reference, an airplane with 20 seats or less is called a commuter or an air taxi.

The seats of such an airliner are generally divided into first class, business class, and economy class.

These classes are divided according to a space of the seat and a service class to be provided.

In other words, the first seat is also called a sleeper seat, in which the seat may be unfolded at 180° to take a lying posture, and the business seat does not lie down like the first class, but has a wide distance from the front seat to take a comfortable posture with legs stretched out.

In contrast, the economy class is cheaper than first class, but lacks convenience.

On the other hand, conventional first and business classes have a wide required space of the seat and cannot create a large demand due to a higher seat price than the price of the economy class.

The idea of a conventional duplex seat has high space efficiency, but it is burdensome to accommodate the interior of an airplane cabin from an airline's viewpoint, so that an improvement plan thereof is required.

The above-described technical configuration is the background art for helping in the understanding of the present disclosure, and does not mean a conventional technology widely known in the art to which the present disclosure pertains.

### SUMMARY OF THE INVENTION

The present disclosure has been made in an effort to provide a seat system for an airplane and an airplane having the same capable of increasing space efficiency and making it possible for a passenger to visually feel stability and luxury in a cabin space by combining an upper seat system and a lower seat system.

According to an aspect of the present disclosure, there is provided a seat system for an airplane including: a lower seat system provided in a first space part of an airplane body; and an upper seat system provided in a second space part disposed above the first space part, in which the upper seat system includes a plurality of seat parts, the plurality of seat parts have a serial arrangement structure, the plurality of seat parts is continuously arranged, and the plurality of seat parts comprises a plurality of third seat parts disposed in series in the second space part.

As an example related to the present disclosure, the plurality of third seat parts may include: a third seat body provided as a seating area for passengers; a first accommodating body configured to block the lines of sight of passengers seated on the third seat body and other passengers and accommodate the third seat body therein; and a second accommodating body providing a more narrowly defined space at a rear side of the first accommodating body and accommodating the third seat body therein.

As an example related to the present disclosure, the first accommodating body may include: a first body wall; a second body wall provided at one end of the first body wall; a third body wall provided at one end of the second body wall, disposed in parallel with the first body wall, and having an open lower end; a fourth body wall provided at one end of the third body wall and disposed in parallel with the second body wall; and a first door provided on the fourth body wall.

As an example related to the present disclosure, the second accommodating body may include: a fifth body wall provided at one end of the second body wall and disposed perpendicular to the third body wall; a sixth body wall provided at one end of the fifth body wall; a seventh body wall provided at one end of the sixth body wall and disposed in parallel with the fifth body wall; and a second door provided on the seventh body wall.

As an example related to the present disclosure, the second body walls of two adjacent third seat parts of the plurality of third seat parts may be detachably coupled to each other using fastening members, the fifth body walls of the two third seat parts may be detachably coupled to each other using fastening members, first doors of the two third seat parts may face opposite directions, and second doors of the two third seat parts may face opposite directions.

As an example related to the present disclosure, the third seat body may include: a third support body; a third hip support body coupled to an upper portion of the third support body and supporting the hips of a passenger; a third back support body coupled to the third hip support body such that an angle is adjusted, and supporting the back or head of a passenger; and a third leg support body coupled to the third hip support body and supporting the legs of a passenger.

As an example related to the present disclosure, the third leg support body of the third seat body accommodated in the second accommodating body may be extendable into the open space formed at the lower end of the third body wall.

As an example related to the present disclosure, the third support body may be coupled to a bottom part of the second space part.

According to the exemplary embodiments of the present disclosure, it is possible to increase space efficiency by combining an upper seat system and a lower seat system.

In addition, it is possible for passengers to visually feel stability and luxury for a cabin space.

Furthermore, it is possible to provide customers with airline seats at a reasonable price.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a seat system for an airplane according to a first exemplary embodiment of the present disclosure;

FIG. 2 is a front cross-sectional view schematically illustrating that the seat system for the airplane illustrated in FIG. 1 is disposed on an airplane body;

FIG. 3 is a perspective view illustrating regions of a side seat part and a first seat part illustrated in FIG. 1;

FIG. 4 is a perspective view schematically illustrating a seat system for an airplane according to a second exemplary embodiment of the present disclosure;

FIG. 5 is a perspective view illustrating a third seat part illustrated in FIG. 4;

FIG. 6 is a perspective view schematically illustrating a seat system for an airplane according to a third exemplary embodiment of the present disclosure;

FIG. 7 is a perspective view schematically illustrating a fourth seat part and a fifth seat part illustrated in FIG. 6; and

FIG. 8 is a perspective view schematically illustrating a seat system for an airplane according to a fourth exemplary embodiment of the present disclosure.

### DETAILED DESCRIPTION OF THE PREFERRED EMBODIMENT

In order to fully understand the present disclosure, operational advantages of the present disclosure and objects to be achieved by implementing the present disclosure, the present disclosure will be described with reference to the accompanying drawings which illustrate preferred exemplary embodiments of the present disclosure and the contents illustrated in the accompanying drawings.

Hereinafter, preferred exemplary embodiments of the present disclosure will be described in detail with reference to the accompanying drawings. Like reference numerals illustrated in the respective drawings designate like members.

The airplane referred to in the exemplary embodiment includes airliners classified according to usage.

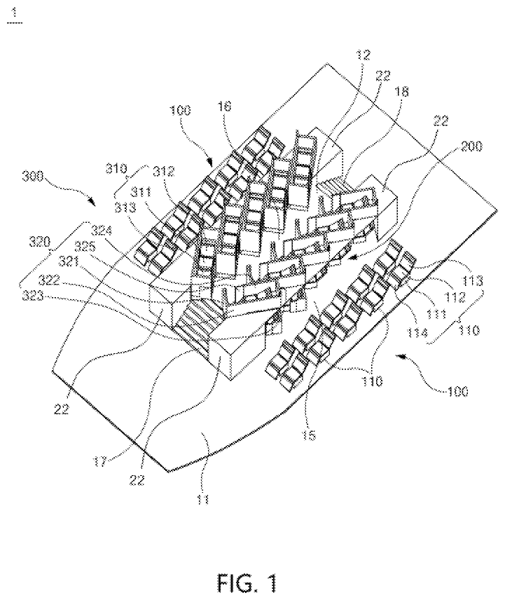

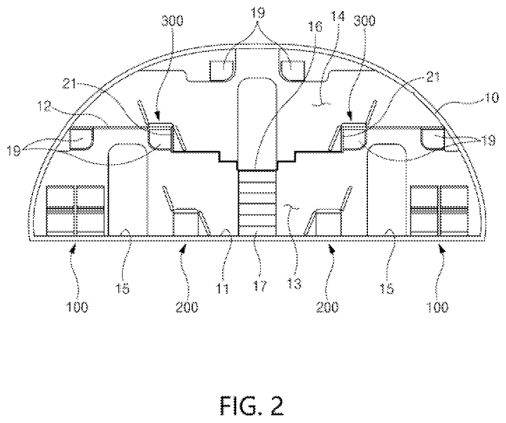

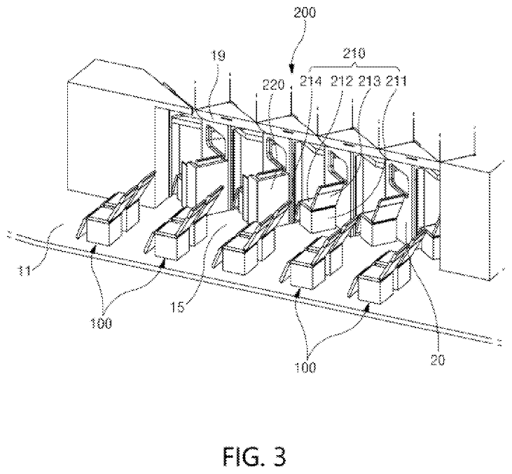

FIG. 1 is a perspective view schematically illustrating a seat system for an airplane according to a first exemplary embodiment of the present disclosure, FIG. 2 is a front cross-sectional view schematically illustrating that the seat system for the airplane illustrated in FIG. 1 is disposed on an airplane body, and FIG. 3 is a perspective view illustrating regions of a side seat part and a first seat part illustrated in FIG. 1.

As illustrated in these drawings, a seat system 1 of an airplane according to the exemplary embodiment includes a lower seat system provided in a first space part 13 of an airplane body 10 and an upper seat system provided in a second space part 14 disposed above the first space part 13.

In the exemplary embodiment, the lower seat system includes a side seat part 100 and a first seat part 200 illustrated in FIG. 1, and the upper seat system includes a plurality of second seat parts 300 having a V-shaped arrangement structure.

As illustrated in FIG. 2, the side seat part 100 may be provided at both side edges of the first space part 13 provided in the airplane body 10 to serve as a seating area for passengers.

In the exemplary embodiment, as illustrated in FIG. 1, the side seat part 100 includes a plurality of side seat bodies 110 arranged in a straight line in a direction from the head to the tail of the airplane. In FIG. 1, the head direction is illustrated with a narrow horizontal width, and the tail direction is illustrated with a wider horizontal width than the head direction.

In the exemplary embodiment, the side seat bodies 110 may be disposed in two rows on the left edge and two rows on the right edge with reference to FIG. 1.

As illustrated in FIG. 1, the side seat body 110 includes a support body 111 coupled to a first bottom part 11, a hip support body 112 coupled to the upper portion of the support body 111 to support the hips of the passenger, a back support body 113 coupled to the hip support body 112 so as to be angled to support the back or head of the passenger, and a leg support body 114 coupled to the hip support body 112 to support the legs of a user.

As illustrated in FIG. 1, the first seat part 200 may be coupled to the first bottom part 11 to be disposed between a pair of side seat parts 100.

In the exemplary embodiment, the first seat part 200 may be disposed in one row in close to the side seat part 100 disposed at the left edge, and disposed in one row in close to the side seat part 100 disposed at the right edge.

In addition, in the exemplary embodiment, the first seat part 200 may be provided to have an overall V-shaped arrangement shape, like the second seat part 300.

In the exemplary embodiment, as illustrated in FIG. 3, the first seat part 200 includes a first seat body 210 coupled to the first bottom part 11.

In the exemplary embodiment, as illustrated in FIG. 3, the first seat body 210 includes a first support body 211 coupled to the first bottom part 11, a first hip support body 212 coupled to the upper portion of the first support body 211 to support the hips of the passenger, a first back support body 213 coupled to the first hip support body 212 so as to be angled to support the back or head of the passenger, and a first leg support body 214 coupled to the first hip support body 212 to support the legs of the user.

In the exemplary embodiment, as illustrated in the front side of FIG. 3, the first seat part 200 further includes a blocking body 220 disposed close to the first seat body 210 to block a line of sight with the passenger sitting on the side seat part 100.

In addition, in the exemplary embodiment, in the region where the first seat part 200 is provided, as illustrated in FIG. 3, a plurality of support partitions 20 are spaced apart from each other to support the second bottom part 12 of the airplane body 10. In the exemplary embodiment, holes or transparent windows may be provided in the plurality of support partitions 20.

In the exemplary embodiment, as illustrated in FIG. 3, a shelf box 19 capable of accommodating portable items of passengers may be provided in the region where the first seat part 200 is provided.

In the exemplary embodiment, the above-described shelf box 19 or shelf may be provided in the front region of the first seat part 200 partitioned by the support partition 20.

As illustrated in FIG. 2, the plurality of second seat parts 300 are provided in the second space part 14 of the airplane body 10, and have a V-shaped arrangement structure as illustrated in FIG. 1.

In the exemplary embodiment, as illustrated in FIG. 1, the plurality of second seat parts 300 includes a second seat body 310 provided as a seating area for passengers, and a seat accommodating body 320 which blocks the lines of sight of passengers seated on the second seat body 310 and other passengers and accommodates the second seat body 310 therein.

In the exemplary embodiment, as illustrated in FIG. 1, the second seat body 310 includes a second hip support body 311, a second back support body 312 coupled to the second hip support body 311 so as to be angled to support the back or head of the passenger, and a second leg support body 313 coupled to the second hip support body 311 to support the legs of the user.

In the exemplary embodiment, unlike the side seat body 110 and the first seat body 210 described above, the second hip support body 311 is not provided with the support body 111, and as illustrated in FIG. 2, the second hip support body 311 may be screwed, bolted, or welded to the second bottom part 12 in a region close to a stepped part 21 provided on the second bottom part 12. To this end, as illustrated in FIG. 2, a central region of the second space part 14 may be provided to be recessed in the direction of the first bottom part 11 or may be provided to be recessed in a step shape.

In the exemplary embodiment, as illustrated in FIG. 1, the seat accommodating body 320 includes a front wall 321 disposed in the head direction of the airplane body 10, a first side wall 322 provided at one end of the front wall 321, a rear wall 323 provided at one end of the first side wall 322 and disposed in parallel with the front wall 321, a second side wall 324 provided at one end of the rear wall 323 and disposed in parallel with the first side wall 322 and shorter than the first side wall 322, and a body door 325 provided on the second side wall 324.

In the exemplary embodiment, the plurality of second seat parts 300 may be disposed so that the first side wall 322 and the second side wall 324 come into contact with each other.

In the exemplary embodiment, the first side wall 322 and the second side wall 324 may be detachably coupled to each other with a fastening member, and the fastening member may include bolts, nuts, and screws.

In the exemplary embodiment, the second seat part 300, as illustrated in FIG. 1, may be disposed above the first seat part 200.

In the exemplary embodiment, the passengers may conveniently move to the second part 12 through a first step 17 disposed in front of the first bottom part 11 and a second step 18 disposed behind the first bottom part 11.

In the exemplary embodiment, the structure of the airplane body 10 applied to the first exemplary embodiment may be equally applied to other exemplary embodiments to be described below.

Meanwhile, in the exemplary embodiment, a monitor 700 and a table 800 may be provided on at least one of the side seat part 100, the first seat part 200, and the second seat part 300. In the exemplary embodiment, the table 800 may have a known coupling means such as sliding coupling, hinge coupling, or the like. The monitor 700 and the table 800 described above may be equally applied to exemplary embodiments to be described below.

In the exemplary embodiment, the side seat body 110, the first seat body 210, and the second seat body 310 may be applied with a known airplane seat structure such as an electric drive or a manual drive as it is.

In the exemplary embodiment, the airplane body 10 may be provided with a pair of first corridors 15 and a second corridor 16 in the second space part 14 above the first corridor 15, as illustrated in FIG. 2. In addition, as illustrated in FIG. 1, four toilets 22 may be provided to be spaced apart from each other in the airplane body 10.

In addition, in the exemplary embodiment, as illustrated in FIG. 2, a body step 23 may be provided in the airplane body 10. In the exemplary embodiment, the body steps 23 may be provided on the left and right sides of the second corridor 16 based on FIG. 2.

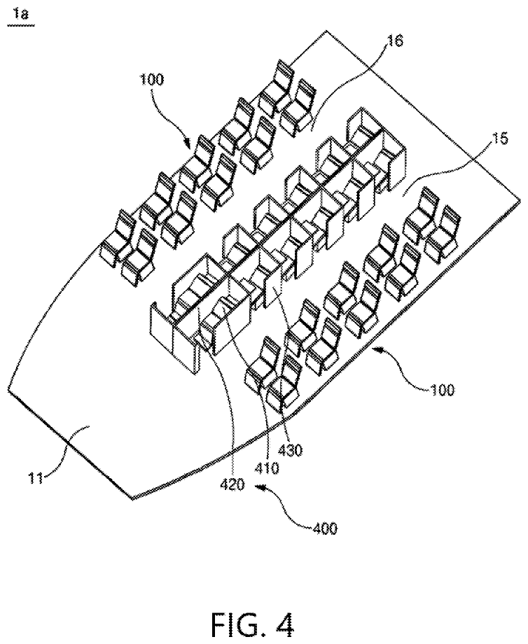

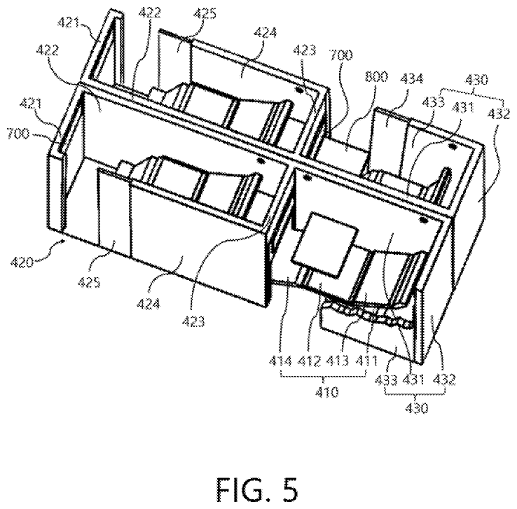

FIG. 4 is a perspective view schematically illustrating a seat system for an airplane according to a second exemplary embodiment of the present disclosure and FIG. 5 is a perspective view illustrating a third seat part 400 illustrated in FIG. 4.

An upper seat system of a seat system 1a of an airplane according to the exemplary embodiment includes a plurality of third seat parts 400 having a serial arrangement structure. In the exemplary embodiment, the plurality of third seat parts 400 may also be provided on the first bottom part 11 of the lower seat system.

In the exemplary embodiment, as illustrated in FIG. 4, the plurality of third seat parts 400 includes a third seat body 410 provided as a seating area for passengers, a first accommodating body 420 which blocks the lines of sight of passengers seated on the third seat body 410 and other passengers and accommodates the third seat body 410 therein, a second accommodating body 430 providing a more narrowly defined space at the rear side of the first accommodating body 420 and accommodating the third seat body 410 therein, a first toilet 440 provided in the head direction so as to be disposed in front of the third seat body 410 disposed in the foremost side, and a second toilet 450 provided in the tail direction so as to be disposed behind the third seat body 410 disposed at the rearmost side.

In the exemplary embodiment, as illustrated in FIG. 5, the third seat body 410 includes a third support body 411, a third hip support body 412 coupled to the upper portion of the third support body 411 to support the hips of the passenger, a third back support body 413 coupled to the third hip support body 412 so as to be angled to support the back or head of the passenger, and a third leg support body 414 coupled to the third hip support body 412 to support the legs of the user.

In the exemplary embodiment, when the third support body 411 is provided on the upper seat system, the third support body 411 may be coupled to the second bottom part 12, and when provided on the lower seat system, the third support body 411 may be coupled to the first bottom part 11.

In the exemplary embodiment, as illustrated in FIG. 5, the third seat bodies 410 may be provided in the first accommodating body 420 and the second accommodating body 430, respectively.

In the exemplary embodiment, as illustrated in FIG. 5, the first accommodating body 420 includes a first body wall 421, a second body wall 422 provided at one end of the first body wall 421, a third body wall 423 provided at one end of the second body wall 422, disposed in parallel with the first body wall 421, and having an open lower end, a fourth body wall 424 provided at one end of the third body wall 423 and disposed in parallel with the second body wall 422, and a first door 425 provided on the fourth body wall 424.

In the exemplary embodiment, the first door 425 may include a known door type such as a slide type, a curtain type, or a hinge type, which may be applied to all of the above-described exemplary embodiments or exemplary embodiments to be described below.

In the exemplary embodiment, as illustrated in FIG. 5, the second accommodating body 430 includes a fifth body wall 431 provided at one end of the second body wall 422 and disposed perpendicular to the third body wall 423, a sixth body wall 432 provided at one end of the fifth body wall 431, a seventh body wall 433 provided at one end of the sixth body wall 432 and disposed in parallel with the fifth body wall 431, and a second door 434 provided on the seventh body wall 433.

In this case, the fifth body wall 431 may be provided at one end of the second body wall 422 or the other end of the third body wall 423, and may be disposed perpendicular to the third body wall 423 or disposed in line with the second body wall 422.

In addition, the sixth body wall 432 may be disposed in parallel with the third body wall 423.

In the exemplary embodiment, the second accommodating body 430 may be disposed continuously from the rear side of the first accommodation body 420. In this case, the third body wall 423 functions as a partition wall partitioning the first accommodating body 420 and the second accommodating body 430, and may be configured such that the lower end thereof is open.

In the exemplary embodiment, the fifth body wall 431 may be configured to be shorter than the second body wall 422. Accordingly, the second accommodating body 430 forms a more narrowly defined space at the rear side of the first accommodating body 420, and at least a portion of the third leg support body 414 of the third seat body 410 accommodated in the second accommodating body 430 may extend into the open space formed at the lower end of the third body wall 423.

In the exemplary embodiment, as shown in FIGS. 4 and 5, the plurality of third seat parts 400 may be arranged such that the second body walls 422 of two adjacent third seat parts 400 are in contact with each other and the fifth body walls 431 of the two adjacent third seat parts 400 are in contact with each other.

In the exemplary embodiment, the second body walls 422 of two adjacent third seat parts 400 may be detachably coupled to each other using fastening members, and the fifth body walls 431 of the two adjacent third seat parts 400 may be detachably coupled to each other using fastening members. In the exemplary embodiment, the fastening member may include bolts and nuts, or screws.

In the exemplary embodiment, the first doors 425 of two adjacent third seat parts 400 may be disposed in opposite directions, and the second doors 434 of the two adjacent third seat parts 400 may be disposed in opposite directions.

In the exemplary embodiment, as shown in FIG. 5, a monitor 700 and a table 800 may be provided at the third seat part 400.

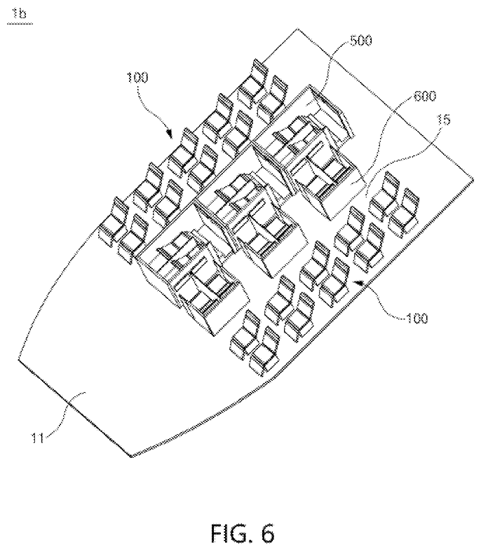

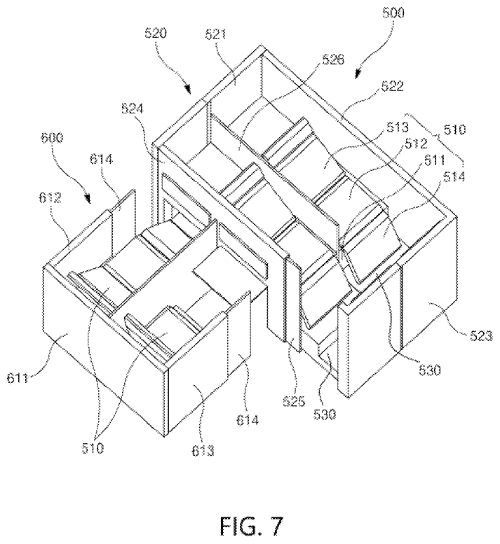

FIG. 6 is a perspective view schematically illustrating a seat system for an airplane according to a third exemplary embodiment of the present disclosure and FIG. 7 is a perspective view schematically illustrating a fourth seat part 500 and a fifth seat part 600 illustrated in FIG. 6.

An upper seat system of a seat system 1b of an airplane according to the exemplary embodiment includes a plurality of fourth seat parts 500 having a linear arrangement structure. In the exemplary embodiment, the plurality of fourth seat parts 500 may also be provided on the first bottom part 11 of the lower seat system.

As illustrated in FIGS. 6 and 7, the plurality of fourth seat parts 500 include a fourth seat body 510 provided as a seating area for passengers, a third accommodating body 520 which blocks the lines of sight of passengers seated on the fourth seat body 510 and other passengers and accommodates the fourth seat body 510 therein, and a seat step 530 provided inside the third accommodating body 520.

In the exemplary embodiment, as illustrated in FIG. 7, the fourth seat body 510 includes a fourth support body 511, a fourth hip support body 512 coupled to the upper portion of the fourth support body 511 to support the hips of the passenger, a fourth back support body 513 coupled to the fourth hip support body 512 so as to be angled to support the back or head of the passenger, and a fourth leg support body 514 coupled to the fourth hip support body 512 to support the legs of the user.

In the exemplary embodiment, when the fourth support body 511 is provided on the upper seat system, the fourth support body 511 may be coupled to the second bottom part 12, and when provided on the lower seat system, the fourth support body 511 may be coupled to the first bottom part 11.

In the exemplary embodiment, as shown in FIG. 7, the third accommodating body 520 may include an eighth body wall 521, a ninth body wall 522 provided at one end of the eighth body wall 521, a tenth body wall 523 provided at one end of the ninth body wall 522 and disposed in parallel with the eighth body wall 521, an eleventh body wall 524 provided at the other end of the eighth body wall 521 and disposed in parallel with the ninth body wall 522, a third door 525 provided on the eleventh body wall 524, and a partition wall 526 provided at the eighth body wall 521 and blocking lines of sight of passengers seated on a pair of fourth seat bodies 510.

In the exemplary embodiment, as illustrated in FIG. 7, the seat step 530 is provided in the third accommodating body 520 so as to be close to the fourth leg support body 514, so that passengers may conveniently use the fourth seat body 510. In the exemplary embodiment, the seat step 530 may be provided by providing a step to the airplane body 10. In addition, in the exemplary embodiment, the seat step 530 may also be prepared by providing a step on the upper surface of the bottom after preparing the bottom part on the third accommodating body 520.

Meanwhile, in the exemplary embodiment, the plurality of fourth seat parts 500 further include a fifth seat part 600 disposed vertically to the fourth seat body 510 and provided as a seating area for passengers.

In the exemplary embodiment, the fifth seat part 600 includes the aforementioned fourth seat body 510 and a fourth accommodating body 610 in which the fourth seat body 510 is accommodated.

In the exemplary embodiment, as shown in FIG. 7, the fourth accommodating body 610 may include a twelfth body wall 611 disposed in parallel with the eleventh body wall 524, a thirteenth body wall 612 provided at one end of the twelfth body wall 611 and disposed in parallel with the eighth body wall 521, a fourteenth body wall 613 provided at the other end of the twelfth body wall 611 and disposed in parallel with the thirteenth body wall 612, and a fourth door 614 provided on the thirteenth body wall 612 and the fourteenth body wall 613.

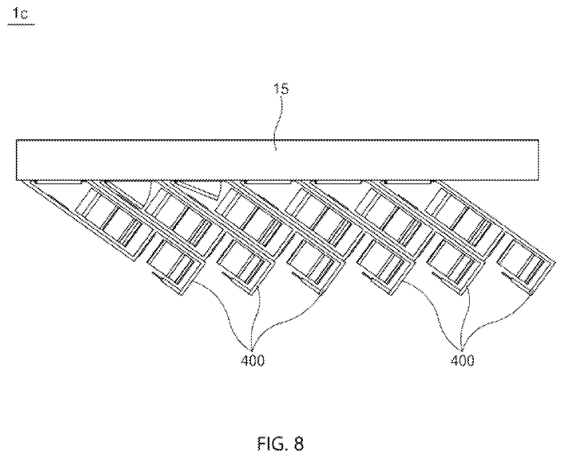

FIG. 8 is a perspective view schematically illustrating a seat system for an airplane according to a fourth exemplary embodiment of the present disclosure.

As illustrated in FIG. 8, a seat system 1c of the airplane according to this exemplary embodiment may also be provided in a hatched shape in a second passage.

At this time, a seat part is illustrated in another exemplary embodiment of the third seat part 400 in which the first body wall 421 is excluded and the first door 425 is provided on the second body wall 422, but is not limited thereto and the seat part of the exemplary embodiment described above may be selectively applied.

The exemplary embodiment may also be applied to a lower seat system.

As described above, the present disclosure is not limited to the exemplary embodiments described herein, and it will be apparent to those skilled in the art that various changes and modifications may be made without departing from the spirit and the scope of the present disclosure. Therefore, it will be understood that these changes and modifications are included in the appended claims of the present disclosure.
1,1a,1b,1c: Seat system of airplane
100: Side seat part
110: Side seat body
111: Support body
112: Hip support body
113: Back support body
114: Leg support body
200: First seat part
210: First seat body
211: First support body
212: First hip support body
213: First back support body
214: First leg support body
220: Blocking body
300: Second seat part
310: Second seat body
311: Second hip support body
312: Second back support body
313: Second leg support body
320: Seat accommodating body
321: Front wall
322: First side wall
323: Rear wall
324: Second side wall
325: Body door
400: Third seat part
410: Third seat body
411: Third support body
412: Third hip support body
413: Third back support body
414: Third leg support body
420: First accommodating body
421: First body wall
422: Second body wall
423: Third body wall
424: Fourth body wall
425: First door
430: Second accommodating body
431: Fifth body wall
432: Sixth body wall
433: Seventh body wall
434: Second door
500: Fourth seat part
510: Fourth seat body
511: Fourth support body
512: Fourth hip support body
513: Fourth back support body
514: Fourth leg support body
520: Third accommodating body
521: Eighth body wall
522: Ninth body wall
523: Tenth body wall
524: Eleventh body wall
525: Third door
526: Partition wall
530: Seat step
600: Fifth seat part
610: Fourth accommodating body
611: Twelfth body wall
612: Thirteenth body wall
613: Fourteenth body wall
614: Fourth door
700: Monitor
800: Table
10: Airplane body
11: First bottom part
12: Second bottom part
13: First space part
14: Second space part
15: First corridor
16: Second corridor
17: First step
18: Second step
19: Shelf box
20: Support partition
21: Step part
22: Toilet
23: Body step

What is claimed is:

1. A seat system for an airplane comprising:
a lower seat system provided in a first space part of an airplane body; and
an upper seat system provided in a second space part disposed above the first space part,
wherein the upper seat system includes a plurality of seat parts,
the plurality of seat parts has a serial arrangement structure,
the plurality of seat parts is continuously arranged, and
the plurality of seat parts comprises a plurality of third seat parts disposed in series in the second space part.

2. The seat system for the airplane of claim 1, wherein the plurality of third seat parts comprises
a third seat body provided as a seating area for passengers;
a first accommodating body configured to block the lines of sight of passengers seated on the third seat body and other passengers and accommodate the third seat body therein; and
a second accommodating body providing a more narrowly defined space at a rear side of the first accommodating body and accommodating the third seat body therein.

3. The seat system for the airplane of claim 2, wherein the first accommodating body comprises
a first body wall;
a second body wall provided at one end of the first body wall;
a third body wall provided at one end of the second body wall, disposed in parallel with the first body wall, and having an open lower end;
a fourth body wall provided at one end of the third body wall and disposed in parallel with the second body wall; and
a first door provided on the fourth body wall.

4. The seat system for the airplane of claim 3, wherein the second accommodating body comprises
a fifth body wall provided at one end of the second body wall and disposed perpendicular to the third body wall;
a sixth body wall provided at one end of the fifth body wall;
a seventh body wall provided at one end of the sixth body wall and disposed in parallel with the fifth body wall; and
a second door provided on the seventh body wall.

5. The seat system for the airplane of claim 4, wherein the second body walls of two adjacent third seat parts of the plurality of third seat parts are detachably coupled to each other using fastening members,
the fifth body walls of the two third seat parts are detachably coupled to each other using fastening members,
first doors of the two third seat parts face opposite directions, and
second doors of the two third seat parts face opposite directions.

6. The seat system for the airplane of claim 3, wherein the third seat body comprises
a third support body;
a third hip support body coupled to an upper portion of the third support body and supporting the hips of a passenger;
a third back support body coupled to the third hip support body such that an angle is adjusted, and supporting the back or head of a passenger; and
a third leg support body coupled to the third hip support body and supporting the legs of a passenger.

7. The seat system for the airplane of claim 6, wherein the third leg support body of the third seat body accommodated in the second accommodating body is extendable into the open space formed at the lower end of the third body wall.

8. The seat system for the airplane of claim 6, wherein the third support body is coupled to a bottom part of the second space part.
